(19) United States
(12) Patent Application Publication
(10) Pub. No.: US 2013/0056918 A1
(43) Pub. Date: Mar. 7, 2013

(54) ENGINE MOUNT FOR VEHICLE

(71) Applicants: Seung Won Kim, Whasung-Si (KR); Yong Jin Kim, Whasung-Si (KR); Yong Lee, Whasung-Si (KR)

(72) Inventors: Seung Won Kim, Whasung-Si (KR); Yong Jin Kim, Whasung-Si (KR); Yong Lee, Whasung-Si (KR)

(73) Assignee: Hyundai Motor Company, Seoul (KR)

(21) Appl. No.: 13/440,498

(22) Filed: Apr. 5, 2012

(30) Foreign Application Priority Data
Sep. 6, 2011 (KR) 10-2011-0089967

(51) Int. Cl. F16F 7/00; F16M 13/02

(52) U.S. Cl. 267/141

(57) ABSTRACT

An engine mount may include an inner core having a bolt fastening portion, to which an engine connection bolt is fastened, and a stopper molding portion integrally formed on a lower end of the bolt fastening portion, and a forward-backward stopper integrally formed on a circumferential surface of the stopper molding portion, an upper insulator formed over a lower surface of the stopper molding portion, a saddle plate integrally formed on a lower surface of the upper insulator during a vulcanization molding, a lower insulator integrally formed on a lower surface of the saddle plate during the vulcanization molding, a fixing plate integrally formed on a lower surface of the lower insulator, a housing surrounding the upper and lower insulators and the forward-backward stopper, and a mounting bracket fastening a contact area between a lower end of the housing and an upper end of the fixing plate.

### CROSS-REFERENCE TO RELATED APPLICATION

The present application claims priority to Korean Patent Application No. 10-2011-0089967 filed Sep. 6, 2011, the entire contents of which is incorporated herein for all purposes by this reference.

### BACKGROUND

1. Field of the Invention

The present invention relates to an engine mount for a vehicle. More particularly, it relates to an engine mount for a vehicle with a new structure, in which insulators are provided at the top and bottom of a saddle plate, thus ensuring durability and three-way static/dynamic characteristics.

2. Description of Related Art

As well known in the art, as a means for reducing the shaking of an engine, which is caused by vibration noise transmitted from an engine room to the interior of a vehicle through the vehicle body and caused by engine vibration, an engine mount with a vibration-proof function is provided between the engine and the vehicle body. In most cases, the engine mount is formed to have a structure in which an insulator made of a rubber material is provided and a viscous liquid is filled to provide vibration damping force.

A conventional engine mount structure will be descried with reference to FIG. 4 below.

A conventional engine mount comprises: an inner core 100, in which a bolt fastening portion 102 is formed at the upper end, a stopper molding portion 104 is integrally formed to protrude from the circumferential surface, and an insulator molding bridge 106 is integrally formed at the lower end; an insulator 110 integrally formed of a rubber material by a vulcanization molding process over the circumferential surface of the bolt fastening portion 102, the outer surface of the stopper molding portion 104, and the insulator molding bridge 106 of the inner core 100; a fixing plate 112 integrally formed on the lower surface of the insulator 110; a housing 120 covered on the insulator 110 and the fixing plate 112; and a mounting bracket 140 tightly fastening the contact area between the bottom of the housing 120 and the top of the fixing plate 112.

Here, the portion of the insulator 110, which is integrally formed with the stopper molding portion 104 of the inner core 100, corresponds to a forward-backward stopper 114 which comes into contact with the inner wall of the housing 120 during deformation, and the lower end of the insulator 110, in which the greatest amount of rubber is present, absorbs forward-backward vibration. Moreover, a groove 116 for increasing forward-backward stiffness is provided on the lower surface of the insulator 110.

Therefore, when a bolt 108 fastened to the bolt fastening portion 102 of the inner core 100 and protruding upward is connected to the engine and the mounting bracket 140 is assembled to the vehicle body, the installation of the engine mount is completed.

Thus, if large forward-backward displacement occurs when the engine vibrates in the forward and backward direction of the vehicle, the forward-backward stopper 114 of the insulator 110, which is integrally formed with the stopper molding portion 104 of the inner core 100, comes into contact with the wall of the housing 120 to absorb the impact and control the large forward-backward displacement, and the groove 116 lowers the forward-backward stiffness for the displacement of the insulator 110.

However, the above-described conventional engine mount has the following problems.

In the event of large deformation of the inner core 100, if the deformation of the insulator 110 formed of rubber is smaller, its durability can be maintained, but excessive compressive deformation of the insulator 110 easily occurs, thus reducing the durability.

Moreover, in the event of displacement of the insulator 110, the groove 116 formed on the lower surface of the insulator 110 lowers the forward-backward stiffness. However, in the event of large displacement of the insulator 110, the groove 116 is easily deformed, thus reducing the durability of the insulator 110.

Furthermore, during acceleration and deceleration on a rough road, the forward-backward damping force of the engine mount is excessive, and thus the upper end of the insulator 110, i.e., the forward-backward stopper 114 integrally formed with the stopper molding portion 104 of the inner core 100 and formed into a small thickness is easily torn, which is very problematic.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an engine mount for a vehicle with a new structure in which the thickness of a forward-backward stopper integrally formed with an inner core is increased and, at the same time, the insulator is divided into upper and lower structures with respect to a saddle plate, thus ensuring durability and three-way static/dynamic characteristics.

In an aspect of the present invention, an engine mount for a vehicle may include an inner core formed at an upper portion of the engine mount and having a bolt fastening portion, to which an engine connection bolt is fastened, and a stopper molding portion integrally formed on a lower end of the bolt fastening portion to protrude from the bolt fastening portion, and a forward-backward stopper integrally formed on a circumferential surface of the stopper molding portion, an upper insulator formed over a lower surface of the stopper molding portion, a saddle plate integrally formed on a lower surface of the upper insulator during a vulcanization molding, a lower insulator integrally formed on a lower surface of the saddle plate during the vulcanization molding, a fixing plate integrally formed on a lower surface of the lower insulator, a housing surrounding the upper and lower insulators and the forward-backward stopper, and a mounting bracket fastening a contact area between a lower end of the housing and an upper end of the fixing plate.

The engine mount may further include a contact preventing space provided between a lower surface of a projection formed to the saddle plate and an upper surface of the lower insulator to prevent the saddle plate from coming into contact with the lower insulator.

The upper insulator is formed of a rubber material by vulcanization molding over the lower surface of the stopper molding portion, wherein the upper insulator and the forward-backward stopper are formed of the rubber material by the vulcanization molding.

The saddle plate may have a container shape with a hole in the middle to function as both a boundary and a stiffness reinforcing structure between the upper and lower insulators and may include a projection integrally formed on an outer circumference and projecting outwardly in a radial direction thereof.

The engine mount may further include a contact preventing space provided between a lower surface of a projection formed to the saddle plate and an upper surface of the lower insulator to prevent the saddle plate from coming into contact with the lower insulator.

An outer diameter of the forward-backward stopper is larger than an outer diameter of the saddle plate.

Other aspects and exemplary embodiments of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is an exploded view of an engine mount for a vehicle in accordance with an exemplary embodiment of the present invention.

FIG. 2 is a cross-sectional view of the engine mount for a vehicle in accordance with an exemplary embodiment of the present invention.

FIG. 3 shows deformation analysis results of the engine mount for a vehicle in accordance with an exemplary embodiment of the present invention.

FIG. 4 is a cross-sectional view of a conventional engine mount.

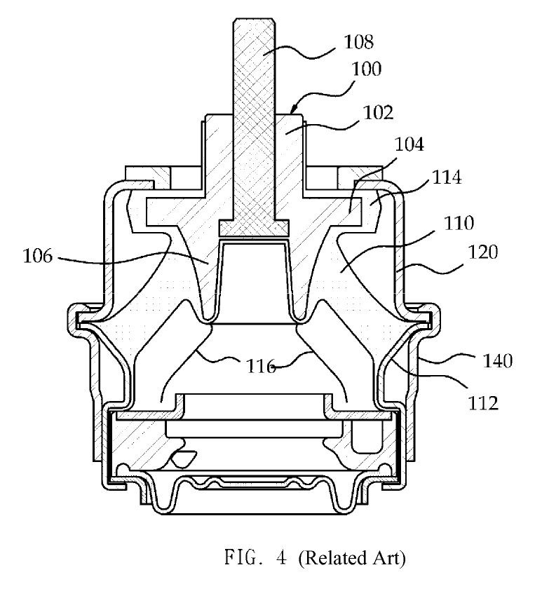

Reference numerals set forth in the Drawings includes reference to the following elements as further discussed below,

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

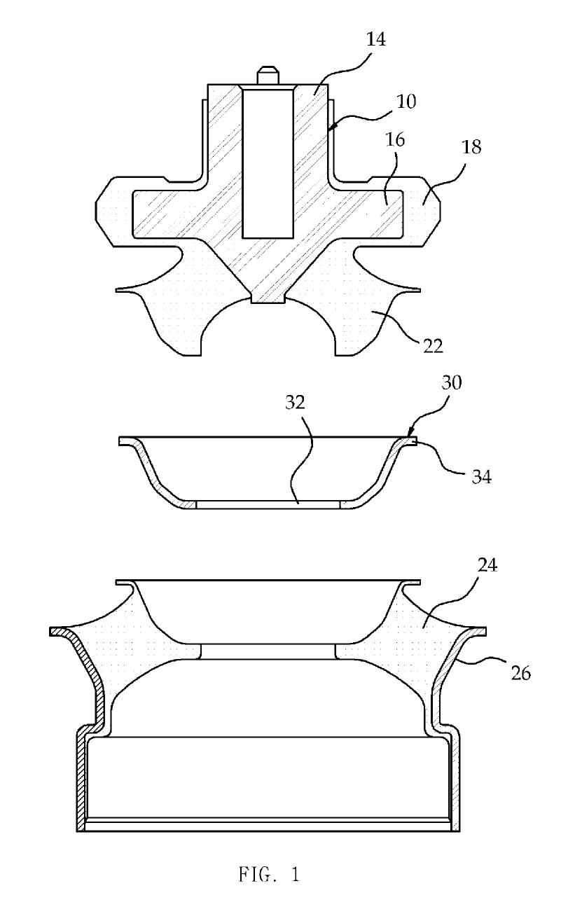

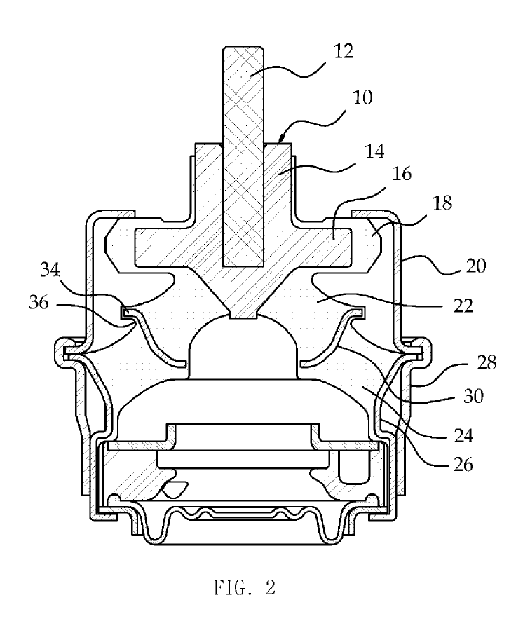

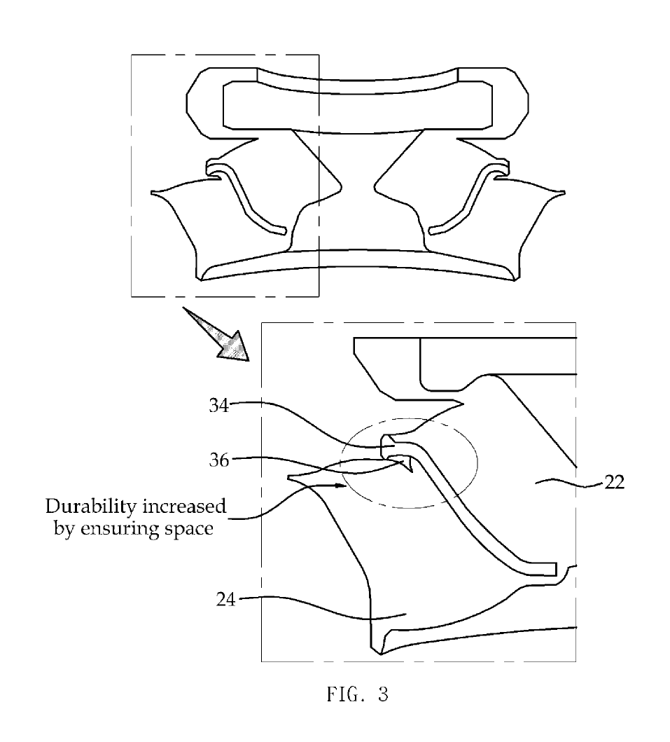

As shown in FIGS. 1 to 3, the present invention aims at providing an engine mount for a vehicle, in which the thickness of a forward-backward stopper 18 integrally formed with an inner core 10 by a vulcanization molding process is increased and, at the same time, the insulator is divided into upper and lower insulators 22 and 24 with respect to a saddle plate 30, thus ensuring durability and three-way static/dynamic characteristics.

To this end, the inner core 10 includes a bolt fastening portion 14, to which an engine connection bolt 12 is fastened, formed at the upper portion and a stopper molding portion 16 integrally formed on the circumferential surface of the lower end and used to mold a forward-backward stopper 18.

Moreover, the engine mount of the present invention includes the saddle plate 30 for dividing the insulator into the upper and lower insulators 22 and 24. The saddle plate 30 has a container shape with a hole 32 in the middle to function as both a boundary and a stiffness reinforcing structure between the upper and lower insulators 22 and 24 and includes a projection 34 integrally formed on the outer circumference and projecting outwardly while maintaining the horizontality.

Here, the inner core 10, the saddle plate 30, and a fixing plate 26 are sequentially placed at regular intervals in a two-piece mold including upper and lower molds, and then a typical rubber vulcanization molding process is performed.

Accordingly, during the rubber vulcanization molding process, a rubber forward-backward stopper 18 is integrally formed with a thickness of about 15 mm on the circumferential surface of the bolt fastening portion 14 of the inner core 10, the upper insulator 22 is integrally formed between the lower surface of the inner core 10 (i.e., the circumferential surface in a reverse conical shape) and the upper surface of the saddle plate 30, and the lower insulator 24 is integrally formed between the lower surface of the saddle plate 30 and the upper surface of the fixing plate 26.

Thus, the engine mount of the present invention includes the upper insulator 22 formed of rubber by vulcanization molding over the circumferential surface and lower surface of the stopper molding portion 16 of the inner core 10, the saddle plate 30 integrally formed on the lower surface of the upper insulator 22 during the vulcanization molding, the lower insulator 24 integrally formed on the lower surface of the saddle plate 30 during the vulcanization molding, and the fixing plate 26 integrally formed on the lower surface of the lower insulator 24.

In particular, a contact preventing space 36 having a concave-convex shape is provided between the flat lower surface of the projection 34 of the saddle plate 30 and the inclined upper surface of the lower insulator 24 to prevent the saddle plate 30 from coming into contact with the lower insulator 24, even when the saddle plate 30 is pressed downward by the pressure due to the downward deformation of the upper insulator 22, thus preventing the lower insulator 24 from being deformed and maintaining the durability of the lower insulator 24.

Meanwhile, the forward-backward stopper 18 formed on the stopper molding portion 16 by vulcanization molding and the upper and lower insulators 22 and 24 are surrounded by a housing 20, and the contact area between the lower end of the housing 20 and the upper end of the fixing plate 26 is tightly fastened by a mounting bracket 28.

That is, the mounting bracket 28 is fastened by a curling process to the contact area between the lower end of the housing 20 and the upper end of the fixing plate 26, thereby completing the engine mount of the present invention.

In a state where the bolt fastening portion 14 of the thus completed engine mount of the present invention is fixedly mounted on the engine and, at the same time, the mounting bracket 28 is fixed to the surface of the engine room, if large forward-backward displacement occurs when the engine vibrates in the forward and backward direction of the vehicle, the forward-backward stopper 18, which has an increased damping area due to an increase in the amount of rubber, comes into contact with the wall of the housing 20, thereby easily absorbing the impact due to the large forward-backward displacement.

Moreover, since the size of the upper insulator 22 formed above the saddle plate 30 is increased and, at the same time, the size of the lower insulator 24 formed below the saddle plate 30 is reduced, it is possible to easily disperse the upward-downward displacement as well as the forward-backward displacement to the upper and lower insulators 22 and 24.

As described above, the present invention provides the following effects.

The amount of rubber used in the forward-backward stopper at the upper end is increased and, at the same time, the upper and lower insulators are provided above and below the saddle plate, and thus it is possible to ensure durability and three-way static/dynamic characteristics.

Moreover, the upper and lower insulators are provided in a two-stage structure without compression with respect to the saddle plate, and the separate contact preventing space is provided between the outer circumference of the saddle plate and the lower insulator, and thus it is possible to ensure the space where the upper insulator and the lower insulator move without compression and to prevent the outer circumference of the saddle plate from coming into press contact with the lower insulator in the event of deformation.

For convenience in explanation and accurate definition in the appended claims, the terms “upper”, “lower”, “inner” and “outer”, are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine mount for a vehicle, the engine mount comprising:
an inner core formed at an upper portion of the engine mount and including:
a bolt fastening portion, to which an engine connection bolt is fastened; and
a stopper molding portion integrally formed on a lower end of the bolt fastening portion to protrude from the bolt fastening portion; and
a forward-backward stopper integrally formed on a circumferential surface of the stopper molding portion;
an upper insulator formed over a lower surface of the stopper molding portion;
a saddle plate integrally formed on a lower surface of the upper insulator during a vulcanization molding;
a lower insulator integrally formed on a lower surface of the saddle plate during the vulcanization molding;
a fixing plate integrally formed on a lower surface of the lower insulator;
a housing surrounding the upper and lower insulators and the forward-backward stopper; and
a mounting bracket fastening a contact area between a lower end of the housing and an upper end of the fixing plate.

2. The engine mount of claim 1, further comprising a contact preventing space provided between a lower surface of a projection formed to the saddle plate and an upper surface of the lower insulator to prevent the saddle plate from coming into contact with the lower insulator.

3. The engine mount of claim 1, wherein the upper insulator is formed of a rubber material by vulcanization molding over the lower surface of the stopper molding portion.

4. The engine mount of claim 3, wherein the upper insulator and the forward-backward stopper are formed of the rubber material by the vulcanization molding.

5. The engine mount of claim 1, wherein the saddle plate has a container shape with a hole in the middle to function as both a boundary and a stiffness reinforcing structure between the upper and lower insulators and includes a projection integrally formed on an outer circumference and projecting outwardly in a radial direction thereof.

6. The engine mount of claim 5, further comprising a contact preventing space provided between a lower surface of a projection formed to the saddle plate and an upper surface of the lower insulator to prevent the saddle plate from coming into contact with the lower insulator.

7. The engine mount of claim 1, wherein an outer diameter of the forward-backward stopper is larger than an outer diameter of the saddle plate.
